(19) United States
(12) Patent Application Publication
(10) Pub. No.: US 2026/0137981 A1
(43) Pub. Date: May 21, 2026

(54) METHOD OF RECOMMENDING EXERCISE BASED ON QUESTION SIMILARITY AND EXERCISE RECOMMENDING SYSTEM PERFORMING THE SAME

(71) Applicant: THE AI LAB, INC., Seoul (KR)

(72) Inventors: Yafeng DENG, Beijing (CN); Young-June CHOI, Seoul (KR)

(21) Appl. No.: 19/378,721

(22) Filed: Nov. 4, 2025

(30) Foreign Application Priority Data
Nov. 18, 2024 (KR) 10-2024-0163778

(51) Int. Cl. A63B 24/00

(52) U.S. Cl. CPC A63B 24/0075; A63B 2024/0081

(57) ABSTRACT

In methods of recommending exercise, first to n-th text combinations are generated for first to n-th questions, which are embedded into first to n-th question vectors, cosine similarity between the first to n-th question vectors is calculated to generate a question similarity matrix, first and second correlation matrices are generated based on information on whether other users answered the first to n-th questions correctly, first and second determination matrices are generated by multiplying the question similarity matrix to the first and second correlation matrices, respectively, answering results of a target user for some of the first to n-th questions are received, similarity scores for remaining questions except for a question that the target user answered incorrectly among the first to n-th questions is calculated using the determination matrices, and some of the first to n-th questions are recommended to the target user in descending order of the similarity scores.

### CROSS-REFERENCE TO RELATED APPLICATION

This application claims priority under 35 USC § 119 to Korean Patent Application No. 10-2024-0163778 filed on Nov. 18, 2024 in the Korean Intellectual Property Office (KIPO), the contents of which are herein incorporated by reference in their entirety.

### BACKGROUND

### 1. Technical Field

Example embodiments relate generally to a technique for recommending exercise suitable for a user, and more particularly to methods of recommending exercise based on question similarity, and exercise recommending systems performing the methods of recommending exercise.

### 2. Description of the Related Art

With recent advancements in information and communication technology (ICT), online educational services are also increasing. Consequently, personalized educational services, previously unavailable through offline education, are also diversifying. For example, services that utilize artificial intelligence to provide personalized educational content based on a user's knowledge level are now available.

In education, collaborative filtering (CF) is commonly used to recommend exercise content. Collaborative filtering is a method that collects users' question-solving results and then predicts the correct answer rate for a given new question. That is, by comparing users with similar question-solving histories in the past, the accuracy rate is predicted based on the assumption that other users' responses to new questions will be similar to the user's own. Collaborative filtering recommends users the question with the highest probability of incorrect answer, i.e., the lowest predicted correct answer rate.

However, collaborative filtering suffers from the problem that it simply recommends questions with the highest probability of incorrect answer, failing to recommend the questions users truly need. For example, a user with a current score of 50 might be presented with a question that a user with a score of 90 could barely solve, simply because of its high probability of incorrect answer.

Therefore, according to the conventional collaborative filtering method, users are only recommended difficult questions that are not very helpful for learning, which leads to a problem of lowering the overall learning efficiency.

### SUMMARY

At least one example embodiment of the present disclosure provides a method of recommending exercise capable of recommending the most suitable question for a user to learn based on the similarity between questions.

At least one example embodiment of the present disclosure provides an exercise recommending system capable of recommending the most suitable question for a user to learn based on the similarity between questions.

According to example embodiments, in a method of recommending exercise, the method is performed by executing instructions using a processor, and the instructions are stored in a non-transitory computer-readable medium. For first to n-th questions, first to n-th text combinations are generated by combining at least some of a question text, which corresponds to a question itself, a hint text for the question, and a correct answer text for the question, where n is an integer greater than or equal to 2. The first to n-th text combinations are embedded into first to n-th question vectors having a predetermined length. Cosine similarity between the first to n-th question vectors is calculated to generate a question similarity matrix of size n*n in which a cosine similarity between a p-th question vector and a q-th question vector is an element (p, q), where p and q are positive integers less than or equal to n. A first correlation matrix of size n*n is generated by calculating Equation 1 below based on information on whether first to k-th users answered the first to n-th questions correctly or incorrectly, where k is an integer greater than or equal to 2.

$$R M 1 \_ ( r , s ) = \frac{c\_rs}{\sqrt{c\_r * c\_s}} \qquad [ Equation 1 ]$$

In Equation 1, r and s represent positive integers less than or equal to n, RM1_(r, s) represents an element (r, s) of the first correlation matrix, c_r represents a number of users among the first to k-th users who correctly answered a r-th question, c_s represents a number of users among the first to k-th users who correctly answered a s-th question, and c_rs represents a number of users among the first to k-th users who correctly answered both the r-th question and the s-th question.

In addition, a second correlation matrix of size n*n is generated by calculating Equation 2 below based on the information on whether the first to k-th users answered the first to n-th questions correctly or incorrectly.

$$RM2\_ ( r , s ) = \frac{i\_rs}{\sqrt{i\_r * i\_s}} \qquad [ Equation 2 ]$$

In Equation 2, r and s represent positive integers less than or equal to n, RM2_(r, s) represents an element (r, s) of the second correlation matrix, i_r represents a number of users among the first to k-th users who incorrectly answered a r-th question, i_s represents a number of users among the first to k-th users who incorrectly answered a s-th question, and i_rs represents a number of users among the first to k-th users who incorrectly answered both the r-th question and the s-th question.

In addition, a first determination matrix is generated by multiplying the question similarity matrix and the first correlation matrix. A second determination matrix is generated by multiplying the question similarity matrix and the second correlation matrix. Some of the first to n-th questions is selected to provide the selected questions to a target user. Answering results of the target user for the provided questions are received. When the target user incorrectly answers a t-th question among the provided questions, a similarity score for each of the remaining questions except for the t-th question among the first to n-th questions is calculated using Equation 3 below, where t is a positive integer less than or equal to n.

$$SC\_j = SDM1\_ ( t , j ) + SDM2\_ ( t , j ) \qquad [ Equation 3 ]$$

In Equation 3, j represents a positive integer less than or equal to n and different from t, SC_j represents the similarity score for a j-th question, SDM1_(t, j) represents an element (t, j) of the first determination matrix, and SDM2_(t, j) represents an element (t, j) of the second determination matrix.

In addition, a predetermined number of questions among the first to n-th questions are recommended to the target user in descending order of the similarity scores.

According to example embodiments, an exercise recommending system includes a processor and a non-transitory computer-readable medium. The non-transitory computer-readable medium stores instructions executed using the processor to recommend exercise. The processor generates, for first to n-th questions, first to n-th text combinations by combining at least some of a question text, which corresponds to a question itself, a hint text for the question, and a correct answer text for the question, where n is an integer greater than or equal to 2, embeds the first to n-th text combinations into first to n-th question vectors having a predetermined length, calculates cosine similarity between the first to n-th question vectors to generate a question similarity matrix of size n*n in which a cosine similarity between a p-th question vector and a q-th question vector is an element (p, q), where p and q are positive integers less than or equal to n, generates a first correlation matrix of size n*n by calculating Equation 1 below based on information on whether first to k-th users answered the first to n-th questions correctly or incorrectly, where k is an integer greater than or equal to 2.

$$RM1\_ ( r , s ) = \frac{c\_rs}{\sqrt{c\_r * c\_s}} \qquad [ Equation 1 ]$$

In Equation 1, r and s represent positive integers less than or equal to n, RM1_(r, s) represents an element (r, s) of the first correlation matrix, c_r represents a number of users among the first to k-th users who correctly answered a r-th question, c_s represents a number of users among the first to k-th users who correctly answered a s-th question, and c_rs represents a number of users among the first to k-th users who correctly answered both the r-th question and the s-th question.

In addition, the processor generates a second correlation matrix of size n*n by calculating Equation 2 below based on the information on whether the first to k-th users answered the first to n-th questions correctly or incorrectly.

$$RM2\_ ( r , s ) = \frac{i\_rs}{\sqrt{i\_r * i\_s}} \qquad [ Equation 2 ]$$

In Equation 2, r and s represent positive integers less than or equal to n, RM2_(r, s) represents an element (r, s) of the second correlation matrix, i_r represents a number of users among the first to k-th users who incorrectly answered a r-th question, i_s represents a number of users among the first to k-th users who incorrectly answered a s-th question, and i_rs represents a number of users among the first to k-th users who incorrectly answered both the r-th question and the s-th question.

In addition, the processor generates a first determination matrix by multiplying the question similarity matrix and the first correlation matrix, generates a second determination matrix by multiplying the question similarity matrix and the second correlation matrix, selects some of the first to n-th questions to provide the selected questions to a target user, and receives answering results of the target user for the provided questions. When the target user incorrectly answers a t-th question among the provided questions, the processor calculates a similarity score for each of the remaining questions except for the t-th question among the first to n-th questions using Equation 3 below, where t is a positive integer less than or equal to n.

$$SC\_j = SDM1\_ ( t , j ) + SDM2\_ ( t , j ) \qquad [ Equation 3 ]$$

In Equation 3, j represents a positive integer less than or equal to n and different from t, SC_j represents the similarity score for a j-th question, SDM1_(t, j) represents an element (t, j) of the first determination matrix, and SDM2_(t, j) represents an element (t, j) of the second determination matrix.

In addition, the processor recommends a predetermined number of questions among the first to n-th questions to the target user in descending order of the similarity scores.

The method of recommending exercise and the exercise recommending system according to example embodiments are capable of recommending one or more questions that are most suitable for the target user using similarities between the first to n-th questions and the answering results of other users, thereby enhancing the learning efficiency of the target user.

### BRIEF DESCRIPTION OF THE DRAWINGS

Illustrative, non-limiting example embodiments will be more clearly understood from the following detailed description taken in conjunction with the accompanying drawings.

FIG. 1 is a flowchart illustrating a method of recommending exercise according to example embodiments.

FIGS. 2 and 3 are block diagrams illustrating an exercise recommending system according to example embodiments.

### DETAILED DESCRIPTION OF THE EMBODIMENTS

Various example embodiments will be described more fully with reference to the accompanying drawings, in which embodiments are shown. The present disclosure may, however, be embodied in many different forms and should not be construed as limited to the embodiments set forth herein. Like reference numerals refer to like elements throughout this application.

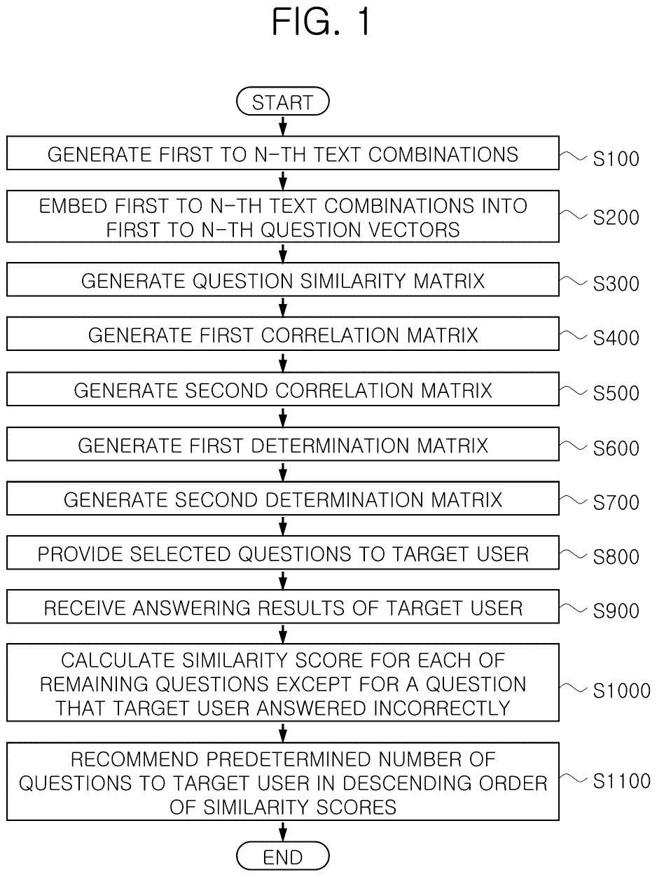

FIG. 1 is a flowchart illustrating a method of recommending exercise according to example embodiments.

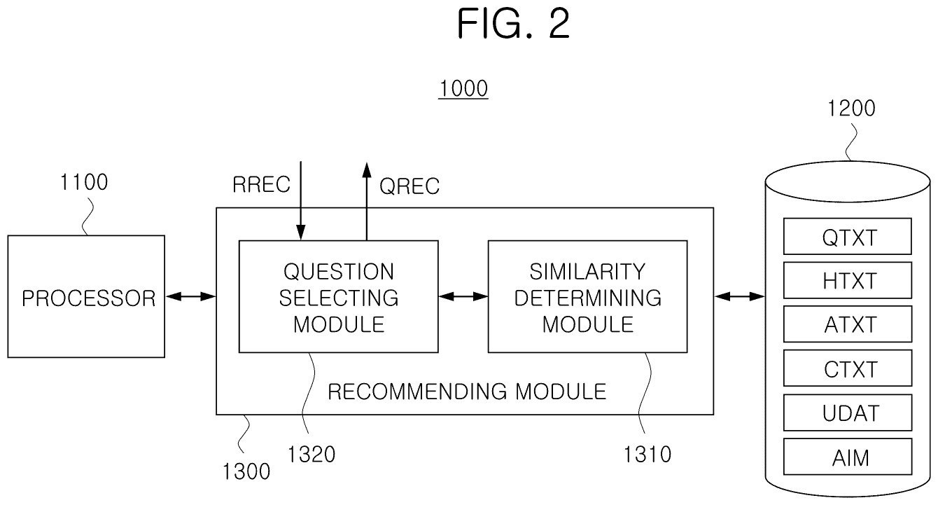

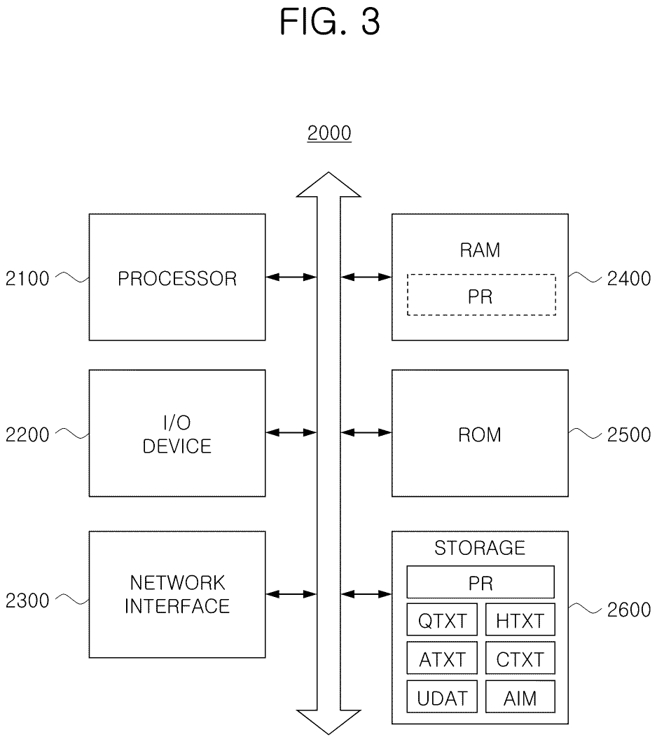

Referring to FIG. 1, a method of recommending exercise according to example embodiments may be performed on a computer-based system and/or tool, at least part of which is implemented in hardware and/or software. For example, the system and/or tool may include program (or software) that includes a plurality of instructions executed using at least one processor. The system and/or tool will be described with reference to FIGS. 2 and 3.

In the method of recommending exercise according to example embodiments, for first to n-th questions, first to n-th text combinations are generated by combining at least some of a question text, which corresponds to a question itself, a hint text, which corresponds to a hint for the question, and a correct answer text, which corresponds to a correct answer for the question (operation S100). Herein, n is an integer greater than or equal to 2.

For example, an i-th text combination may be generated by combining at least some of a question text, which corresponds to an i-th question itself, a hint text, which corresponds to a hint for the i-th question, and a correct answer text, which corresponds to a correct answer for the i-th question. Herein, i is a positive integer less than or equal to n.

In some example embodiments, the i-th text combination may be generated by concatenating the question text, the hint text, and the correct answer text for the i-th question.

In some example embodiments, the question text, the hint text, and the correct answer text for each of the first to n-th questions may be pre-stored in the exercise recommending system that performs the method of recommending exercise according to example embodiments.

Subsequently, the first to n-th text combinations are embedded into first to n-th question vectors having a predetermined length (operation S200). Each element of the first to n-th question vectors may have a real number value.

In some example embodiments, the first to n-th text combinations may be embedded into the first to n-th question vectors having a predetermined length using a sentence transformer related to Natural Language Processing (NLP).

For example, the method of recommending exercise according to example embodiments may embed the first to n-th text combinations into the first to n-th question vectors having a predetermined length using the all-mpnet-base-v2 model.

However, example embodiments are not limited thereto. The method of recommending exercise according to example embodiments may embed the first to n-th text combinations into the first to n-th question vectors having a predetermined length using any widely known artificial intelligence model capable of embedding a sentence including text into a numerical vector of a predetermined length.

Subsequently, cosine similarity between the first to n-th question vectors are calculated to generate a question similarity matrix of size n*n in which a cosine similarity between a p-th question vector and a q-th question vector is an element (p, q) (operation S300). Herein, p and q are positive integers less than or equal to n.

For example, the method of recommending exercise according to example embodiments may calculate the cosine similarity between the p-th question vector and the q-th question vector using Equation 1 below, and determine the cosine similarity calculated by Equation 1 as the element (p, q) of the question similarity matrix.

$$similarity = cos ( Θ ) = \frac{A \cdot B}{‖ A ‖ ‖ B ‖} = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}} \qquad [ Equation 1 ]$$

In Equation 1, A represents the p-th question vector, B represents the q-th question vector, the value calculated by Equation 1 represents the cosine similarity between the p-th question vector and the q-th question vector.

Therefore, the size of the question similarity matrix is n*n, and each element of the question similarity matrix may have a real number value greater than or equal to 0 and less than or equal to 1.

The question similarity matrix may represent how similar the p-th question and the q-th question are. That is, the larger the value of the (p, q) element of the question similarity matrix, the higher the similarity between the p-th question and the q-th question.

Meanwhile, a first correlation matrix of size n*n is generated by calculating Equation 2 below based on information on whether first to k-th users answered the first to n-th questions correctly or incorrectly (operation S400). Herein, k is an integer greater than or equal to 2.

$$RM1\_ ( r , s ) = \frac{c\_rs}{\sqrt{c\_r * c\_s}} \qquad [ Equation 2 ]$$

In Equation 2, r and s represent positive integers less than or equal to n, RM1_(r, s) represents an element (r, s) of the first correlation matrix, c_r represents a number of users among the first to k-th users who correctly answered a r-th question, c_s represents a number of users among the first to k-th users who correctly answered a s-th question, and c_rs represents a number of users among the first to k-th users who correctly answered both the r-th question and the s-th question.

Herein, when c_rs is 0, RM1_(r, s) may be defined as 0.

Therefore, each element of the first correlation matrix may have a real number value greater than or equal to 0 and less than or equal to 1.

The first correlation matrix may represent how likely it is that a user who correctly answered the r-th question will also correctly answer the s-th question. That is, the larger the value of the (r, s) element of the first correlation matrix, the higher the probability that a user who correctly answered the r-th question will also correctly answer the s-th question.

Meanwhile, a second correlation matrix of size n*n is generated by calculating Equation 3 below based on the information on whether the first to k-th users answered the first to n-th questions correctly or incorrectly (operation S500).

$$RM2\_ ( r , s ) = \frac{i\_rs}{\sqrt{i\_r * i\_s}} \qquad [ Equation 3 ]$$

In Equation 3, r and s represent positive integers less than or equal to n, RM2_(r, s) represents an element (r, s) of the second correlation matrix, i_r represents a number of users among the first to k-th users who incorrectly answered a r-th question, i_s represents a number of users among the first to k-th users who incorrectly answered a s-th question, and i_rs represents a number of users among the first to k-th users who incorrectly answered both the r-th question and the s-th question.

Herein, when i_rs is 0, RM2_(r, s) may be defined as 0.

Therefore, each element of the second correlation matrix may have a real number value greater than or equal to 0 and less than or equal to 1.

The second correlation matrix may represent how likely it is that a user who incorrectly answered the r-th question will also incorrectly answer the s-th question. That is, the larger the value of the (r, s) element of the second correlation matrix, the higher the probability that a user who incorrectly answered the r-th question will also incorrectly answer the s-th question.

In some example embodiments, the information on whether the first to k-th users answered the first to n-th questions correctly or incorrectly may be pre-stored in the exercise recommending system that performs the method of recommending exercise according to example embodiments.

Subsequently, a first determination matrix is generated by multiplying the question similarity matrix and the first correlation matrix (operation S600).

As described above, since the question similarity matrix represents how similar the p-th question and the q-th question are, and the first correlation matrix represents how likely it is that a user who correctly answered the r-th question will also correctly answer the s-th question, the first determination matrix may more accurately represent the similarity between the first to n-th questions.

In addition, a second determination matrix is generated by multiplying the question similarity matrix and the second correlation matrix (operation S700).

As described above, since the question similarity matrix represents how similar the p-th question and the q-th question are, and the second correlation matrix represents how likely it is that a user who incorrectly answered the r-th question will also incorrectly answer the s-th question, the second determination matrix may more accurately represent the similarity between the first to n-th questions.

As will be described below, the method of recommending exercise according to example embodiments may use the first determination matrix and the second determination matrix to recommend, based on the answering result of a target user, one or more questions that are most suitable for the target user's learning.

Specifically, some of the first to n-th questions are selected to provide the selected questions to the target user (operation S800).

In some example embodiments, at the beginning of the exercise recommendation for the target user, some of the first to n-th questions may be randomly selected and provided to the target user.

After that, answering results of the target user for the provided questions is received (operation S900).

When the target user incorrectly answers a t-th question among the provided questions, a similarity score for each of the remaining questions except for the t-th question among the first to n-th questions is calculated using Equation 4 below (operation S1000). Herein, t is a positive integer less than or equal to n.

$$SC\_j = SDM1\_ ( t , j ) + SDM2\_ ( t , j ) \qquad [ Equation 4 ]$$

In Equation 4, j represents a positive integer less than or equal to n and different from t, SC_j represents the similarity score for a j-th question, SDM1_(t, j) represents an element (t, j) of the first determination matrix, and SDM2_(t, j) represents an element (t, j) of the second determination matrix.

As described above, since the first determination matrix and the second determination matrix represent the similarity between the first to n-th questions, the similarity score calculated for each of the first to n-th questions using Equation 4 may effectively represent how similar each of the first to n-th questions is to the t-th question that the target user answered incorrectly.

Therefore, in the method of recommending exercise according to example embodiments, a predetermined number of questions among the first to n-th questions are selected in descending order of the similarity scores and are recommended to the target user as recommended questions (operation S1100).

Afterward, upon receiving answering results of the target user for the recommended questions (operation S900), the above-described operations S1000 and S1100 may be performed again to select a predetermined number of questions among the first to n-th questions, which have the highest similarity to a question incorrectly answered by the target user among the recommended questions, and recommend the newly selected questions to the target user as new recommended questions.

As described above, the method of recommending exercise according to example embodiments recommends questions most similar to those that the target user has answered incorrectly, thereby effectively enhancing the learning efficiency of the target user.

Although FIG. 1 illustrates that the respective operations are performed sequentially, example embodiments are not limited thereto, and at least some of the operations may be performed substantially simultaneously.

In other example embodiments, the exercise recommending system that performs the method of recommending exercise according to example embodiments may pre-store information about a plurality of chapters that divide learning contents, a chapter description text representing the learning content for each chapter, and information about the chapter related to each of the first to n-th questions.

In this case, as will be described below, the method of recommending exercise according to other example embodiments may further improve the suitability of exercise recommendation for the target user by additionally using information about the plurality of chapters related to the first to n-th questions.

Specifically, for the first to n-th questions, first to n-th chapter texts may be generated by collecting the chapter description text included in a chapter related to a corresponding question among the plurality of chapters.

For example, an i-th chapter text may be generated by collecting the chapter description text included in a chapter related to an i-th question among the plurality of chapters. If multiple chapters are related to the i-th question, the chapter description texts included in the multiple chapters related to the i-th question may be concatenated to generate the i-th chapter text.

Subsequently, the first to n-th chapter texts may be embedded into first to n-th chapter vectors having a predetermined length. Each element of the first to n-th chapter vectors may have a real number value.

In some example embodiments, the first to n-th chapter texts may be embedded into the first to n-th chapter vectors having a predetermined length using a sentence transformer related to Natural Language Processing (NLP).

For example, the method of recommending exercise according to other example embodiments may embed the first to n-th chapter texts into the first to n-th chapter vectors having a predetermined length using the all-mpnet-base-v2 model.

However, example embodiments are not limited thereto. The method of recommending exercise according to other example embodiments may embed the first to n-th chapter texts into the first to n-th chapter vectors having a predetermined length using any widely known artificial intelligence model capable of embedding a sentence including text into a numerical vector of a predetermined length.

Subsequently, cosine similarity between the first to n-th chapter vectors may be calculated to generate a chapter similarity matrix of size n*n in which a cosine similarity between a p-th chapter vector and a q-th chapter vector is an element (p, q). Herein, p and q are positive integers less than or equal to n.

The process of calculating the cosine similarity between the first to n-th chapter vectors to generate the chapter similarity matrix of size n*n is the same as the process of calculating the cosine similarity between the first to n-th question vectors to generate the question similarity matrix of size n*n described above with reference to Equation 1. Therefore, redundant description of the process of calculating the cosine similarity between the first to n-th chapter vectors to generate the chapter similarity matrix of size n*n will be omitted.

Therefore, the size of the chapter similarity matrix is n*n, and each element of the chapter similarity matrix may have a real number value greater than or equal to 0 and less than or equal to 1.

The chapter similarity matrix may represent how similar a content of a chapter related to the p-th question and a content of a chapter related to the q-th question are. That is, the larger the value of the (p, q) element of the chapter similarity matrix, the higher the similarity between the content of the chapter related to the p-th question and the content of the chapter related to the q-th question.

Subsequently, the first determination matrix may be generated by multiplying the question similarity matrix, the chapter similarity matrix, and the first correlation matrix.

As described above, since the question similarity matrix represents how similar the p-th question and the q-th question are, the chapter similarity matrix represents how similar the content of the chapter related to the p-th question and the content of the chapter related to the q-th question are, and the first correlation matrix represents how likely it is that a user who correctly answered the r-th question will also correctly answer the s-th question, the first determination matrix may more accurately represent the similarity between the first to n-th questions.

In addition, the second determination matrix may be generated by multiplying the question similarity matrix, the chapter similarity matrix, and the second correlation matrix.

As described above, since the question similarity matrix represents how similar the p-th question and the q-th question are, the chapter similarity matrix represents how similar the content of the chapter related to the p-th question and the content of the chapter related to the q-th question are, and the second correlation matrix represents how likely it is that a user who incorrectly answered the r-th question will also incorrectly answer the s-th question, the second determination matrix may more accurately represent the similarity between the first to n-th questions.

Subsequently, the method of recommending exercise according to other example embodiments may perform the above-described operations S800, S900, S1000 and S1100 using the first determination matrix and the second determination matrix, which are generated by additionally using information about the plurality of chapters related to the first to n-th questions, to recommend one or more questions that are most suitable for the target user's learning among the first to n-th questions.

As described above, the method of recommending exercise according to other example embodiments recommends, by additionally using information about the plurality of chapters related to the first to n-th questions, questions most similar to those that the target user has answered incorrectly, thereby further effectively enhancing the learning efficiency of the target user.

FIGS. 2 and 3 are block diagrams illustrating an exercise recommending system according to example embodiments.

Referring to FIG. 2, an exercise recommending system 1000 includes a processor 1100, a database 1200, and a recommending module 1300.

Herein, the term “module” may indicate, but is not limited to, a software and/or hardware component, such as a field programmable gate array (FPGA) or an application specific integrated circuit (ASIC), which performs certain tasks. A “module” may be configured to reside in a tangible addressable storage medium and be configured to execute on one or more processors. For example, a “module” may include components such as software components, object-oriented software components, class components and task components, and processes, functions, routines, segments of program code, drivers, firmware, microcode, circuitry, data, databases, data structures, tables, arrays, and variables. A “module” may be divided into a plurality of “modules” that perform detailed functions.

The processor 1100 may be used to control an operation of the exercise recommending system 1000 and may be used when the recommending module 1300 performs computations or calculations. For example, the processor 1100 may include a microprocessor, an application processor (AP), a central processing unit (CPU), a digital signal processor (DSP), a graphic processing unit (GPU), a neural processing unit (NPU), or the like.

The database 1200 may store data used for the operation of the exercise recommending system 1000. For example, the database 1200 may store, for each of the first to n-th questions, a question text QTXT, which corresponds to a question itself, a hint text HTXT, which corresponds to a hint for the question, and a correct answer text ATXT, which corresponds to a correct answer for the question. In addition, the database 1200 may store a chapter description text CTXT representing a learning content for each of the plurality of chapters related to the first to n-th questions, and a user data UDAT representing information on whether the first to k-th users answered the first to n-th questions correctly or incorrectly. Further, the database 1200 may also store various other related data. For example, the database 1200 may store data AIM related to an artificial intelligence model for embedding the first to n-th text combinations into the first to n-th question vectors having a predetermined length and embedding the first to n-th chapter texts into the first to n-th chapter vectors having a predetermined length.

In some example embodiments, the database 1200 may include an arbitrary non-transitory computer-readable storage medium (or device) used to provide commands and/or data to a computer. For example, the non-transitory computer-readable storage medium may include a volatile memory such as a static random access memory (SRAM), a dynamic random access memory (DRAM), or the like, and a nonvolatile memory such as a flash memory, a magnetic random access memory (MRAM), a phase-change random access memory (PRAM), a resistive random access memory (RRAM), a ferroelectric random access memory (FRAM), or the like. The non-transitory computer-readable storage medium may be inserted into the computer, may be integrated in the computer, or may be coupled to the computer through a communication medium such as a network and/or a wireless link.

The recommending module 1300 may perform the method of recommending exercise according to example embodiments described with reference to FIG. 1. The recommending module 1300 may include a similarity determining module 1310 and a question selecting module 1320.

The similarity determining module 1310 may receive the question text QTXT, the hint text HTXT, and the correct answer text ATXT for each of the first to n-th questions from the database 1200. The similarity determining module 1310 may generate, for the first to n-th questions, the first to n-th text combinations by combining at least some of the question text QTXT, the hint text HTXT, and the correct answer text ATXT for a corresponding question. In other words, the similarity determining module 1310 may perform operation S100 of FIG. 1.

The similarity determining module 1310 may embed the first to n-th text combinations into the first to n-th question vectors having a predetermined length using the data AIM related to an artificial intelligence model stored in the database 1200. In other words, the similarity determining module 1310 may perform operation S200 of FIG. 1.

The similarity determining module 1310 may calculate cosine similarity between the first to n-th question vectors to generate the question similarity matrix of size n*n in which a cosine similarity between a p-th question vector and a q-th question vector is an element (p, q). In other words, the similarity determining module 1310 may perform operation S300 of FIG. 1.

In some example embodiments, the similarity determining module 1310 may further receive the chapter description text CTXT representing a learning content for each of the plurality of chapters related to the first to n-th questions from the database 1200. In this case, the similarity determining module 1310 may generate, for the first to n-th questions, the first to n-th chapter texts by collecting the chapter description text CTXT included in a chapter related to a corresponding question among the plurality of chapters.

The similarity determining module 1310 may embed the first to n-th chapter texts into the first to n-th chapter vectors having a predetermined length using the data AIM related to an artificial intelligence model stored in the database 1200.

The similarity determining module 1310 may calculate cosine similarity between the first to n-th chapter vectors to generate the chapter similarity matrix of size n*n in which a cosine similarity between a p-th chapter vector and a q-th chapter vector is an element (p, q).

The similarity determining module 1310 may generate the first correlation matrix of size n*n by calculating Equation 2 above using the user data UDAT representing information on whether the first to k-th users answered the first to n-th questions correctly or incorrectly. In other words, the similarity determining module 1310 may perform operation S400 of FIG. 1.

In addition, the similarity determining module 1310 may generate the second correlation matrix of size n*n by calculating Equation 3 above using the user data UDAT representing information on whether the first to k-th users answered the first to n-th questions correctly or incorrectly. In other words, the similarity determining module 1310 may perform operation S500 of FIG. 1.

In some example embodiments, the similarity determining module 1310 may generate the first determination matrix by multiplying the question similarity matrix and the first correlation matrix, and generate the second determination matrix by multiplying the question similarity matrix and the second correlation matrix. In other words, the similarity determining module 1310 may perform operations S600 and S700 of FIG. 1.

In other example embodiments, the similarity determining module 1310 may generate the first determination matrix by multiplying the question similarity matrix, the chapter similarity matrix, and the first correlation matrix, and generate the second determination matrix by multiplying the question similarity matrix, the chapter similarity matrix, and the second correlation matrix.

At the beginning of the exercise recommendation for the target user, the question selecting module 1320 may randomly select some of the first to n-th questions and provide the selected questions as recommended questions QREC. In other words, the question selecting module 1320 may perform operation S800 of FIG. 1.

After that, the question selecting module 1320 may receive answering results RREC of the target user for the recommended questions QREC. In other words, the question selecting module 1320 may perform operation S900 of FIG. 1.

When the target user incorrectly answers a t-th question among the recommended questions QREC, the question selecting module 1320 may calculate a similarity score for each of the remaining questions except for the t-th question among the first to n-th questions using Equation 4 above. In other words, the question selecting module 1320 may perform operation S1000 of FIG. 1.

Subsequently, the question selecting module 1320 may select a predetermined number of questions among the first to n-th questions in descending order of the similarity scores and recommend the selected questions to the target user as the recommended questions QREC. In other words, the question selecting module 1320 may perform operation S1100 of FIG. 1.

In some example embodiments, the similarity determining module 1310 and the question selecting module 1320 may be implemented as instructions or program codes that may be executed by the processor 1100. In other example embodiments, the processor 1100 may be manufactured to efficiently execute instructions or program codes included in the similarity determining module 1310 and the question selecting module 1320.

In some example embodiments, the similarity determining module 1310 and the question selecting module 1320 may be implemented as a single integrated module. In other example embodiments, the similarity determining module 1310 and the question selecting module 1320 may be implemented as separate and different modules.

Referring to FIG. 3, an exercise recommending system 2000 includes a processor 2100, an input/output (I/O) device 2200, a network interface 2300, a random access memory (RAM) 2400, a read only memory (ROM) 2500, and a storage device 2600. FIG. 3 illustrates an example where all of the similarity determining module 1310 and the question selecting module 1320 of FIG. 2 are implemented in software.

The processor 2100 may be substantially the same as the processor 1100 of FIG. 2. For example, the processor 2100 may access a memory (e.g., the RAM 2400 or the ROM 2500) through a bus, and may execute instructions stored in the RAM 2400 or the ROM 2500. As illustrated in FIG. 3, the RAM 2400 may store a program PR corresponding to the similarity determining module 1310 and the question selecting module 1320 of FIG. 2 or at least some elements of the program PR, and the program PR may allow the processor 2100 to perform operations for recommending exercise (e.g., operations S100 to S1100 of FIG. 1).

The storage device 2600 may store the program PR. The program PR or at least some elements of the program PR may be loaded from the storage device 2600 to the RAM 2400 before being executed by the processor 2100. The storage device 2600 may store a file written in a program language, and the program PR generated by a compiler or the like or at least some elements of the program PR may be loaded to the RAM 2400.

In addition, the storage device 2600 may store the question text QTXT, the hint text HTXT, and the correct answer text ATXT for each of the first to n-th questions, the chapter description text CTXT representing a learning content for each of the plurality of chapters related to the first to n-th questions, the user data UDAT representing information on whether the first to k-th users answered the first to n-th questions correctly or incorrectly, and the data AIM related to an artificial intelligence model. In other words, the storage device 2600 may function as the database 1200 of FIG. 2.

The I/O device 2200 may include an input device, such as a keyboard, a pointing device, or the like, and may include an output device such as a display device, a printer, or the like. For example, a manager may trigger, through the I/O devices 2200, execution of the program PR by the processor 2100, and may provide or check various inputs, outputs and/or data, etc.

The network interface 2300 may provide access to a network outside the exercise recommending system 2000. For example, the network may include a plurality of computing systems and communication links, and the communication links may include wired links, optical links, wireless links, or arbitrary other type links. Various inputs may be provided to the exercise recommending system 2000 through the network interface 2300, and various outputs may be provided to another computing system through the network interface 2300.

In some example embodiments, the computer program codes and the recommending module 1300 may be stored in a transitory or non-transitory computer-readable medium. In some example embodiments, various intermediate data and/or result data obtained from arithmetic processing performed by the processor may be stored in a transitory or non-transitory computer-readable medium. However, example embodiments are not limited thereto.

In some example embodiments, the exercise recommending system 1000 and 2000 of FIGS. 2 and 3 may be implemented in the form of various electronic systems such as a personal computer (PC), a server computer, a data center, a workstation, a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, a drone, an automotive, etc.

The example embodiments may be applied to various exercise recommending systems and artificial intelligence systems.

The foregoing is illustrative of example embodiments and is not to be construed as limiting thereof. Although some example embodiments have been described, those skilled in the art will readily appreciate that many modifications are possible in the example embodiments without materially departing from the novel teachings and advantages of the example embodiments. Accordingly, all such modifications are intended to be included within the scope of the example embodiments as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of recommending exercise, the method being performed by executing instructions using a processor, the instructions being stored in a non-transitory computer-readable medium, the method comprising:
generating, for first to n-th questions, first to n-th text combinations by combining at least some of a question text, which corresponds to a question itself, a hint text for the question, and a correct answer text for the question, n being an integer greater than or equal to 2;
embedding the first to n-th text combinations into first to n-th question vectors having a predetermined length;
calculating cosine similarity between the first to n-th question vectors to generate a question similarity matrix of size n*n in which a cosine similarity between a p-th question vector and a q-th question vector is an element (p, q), p and q being positive integers less than or equal to n;
generating a first correlation matrix of size n*n by calculating Equation 1 below based on information on whether first to k-th users answered the first to n-th questions correctly or incorrectly, k being an integer greater than or equal to 2,
$$RM1\_ ( r , s ) = \frac{c\_rs}{\sqrt{c\_r * c\_s}} \qquad [ Equation 1 ]$$
wherein in Equation 1, r and s represent positive integers less than or equal to n, RM1_(r, s) represents an element (r, s) of the first correlation matrix, c_r represents a number of users among the first to k-th users who correctly answered a r-th question, c_s represents a number of users among the first to k-th users who correctly answered a s-th question, and c_rs represents a number of users among the first to k-th users who correctly answered both the r-th question and the s-th question;
generating a second correlation matrix of size n*n by calculating Equation 2 below based on the information on whether the first to k-th users answered the first to n-th questions correctly or incorrectly,
$$RM2\_ ( r , s ) = \frac{i\_rs}{\sqrt{i\_r * i\_s}} \qquad [ Equation 2 ]$$
wherein in Equation 2, r and s represent positive integers less than or equal to n, RM2_(r, s) represents an element (r, s) of the second correlation matrix, i_r represents a number of users among the first to k-th users who incorrectly answered a r-th question, is represents a number of users among the first to k-th users who incorrectly answered a s-th question, and i_rs represents a number of users among the first to k-th users who incorrectly answered both the r-th question and the s-th question;
generating a first determination matrix by multiplying the question similarity matrix and the first correlation matrix;
generating a second determination matrix by multiplying the question similarity matrix and the second correlation matrix;
selecting some of the first to n-th questions to provide the selected questions to a target user;
receiving answering results of the target user for the provided questions;
when the target user incorrectly answers a t-th question among the provided questions, calculating a similarity score for each of the remaining questions except for the t-th question among the first to n-th questions using Equation 3 below, t being a positive integer less than or equal to n,
$$SC\_j = SDM1\_ ( t , j ) + SDM2\_ ( t , j ) \qquad [ Equation 3 ]$$
wherein in Equation 3, j represents a positive integer less than or equal to n and different from t, SC_j represents the similarity score for a j-th question, SDM1_(t, j) represents an element (t, j) of the first determination matrix, and SDM2_(t, j) represents an element (t, j) of the second determination matrix; and
recommending a predetermined number of questions among the first to n-th questions to the target user in descending order of the similarity scores.

2. The method of claim 1, wherein the embedding the first to n-th text combinations into the first to n-th question vectors having a predetermined length comprises:
embedding the first to n-th text combinations into the first to n-th question vectors having a predetermined length using a sentence transformer related to Natural Language Processing (NLP).

3. The method of claim 1, further comprising:
generating, for the first to n-th questions, first to n-th chapter texts by collecting a chapter description text included in a chapter related to a corresponding question among a plurality of chapters;
embedding the first to n-th chapter texts into first to n-th chapter vectors having a predetermined length; and
calculating cosine similarity between the first to n-th chapter vectors to generate a chapter similarity matrix of size n*n in which a cosine similarity between a p-th chapter vector and a q-th chapter vector is an element (p, q),
wherein the generating the first determination matrix comprises:
generating the first determination matrix by multiplying the question similarity matrix, the chapter similarity matrix, and the first correlation matrix, and
wherein the generating the second determination matrix comprises:
generating the second determination matrix by multiplying the question similarity matrix, the chapter similarity matrix, and the second correlation matrix.

4. An exercise recommending system comprising:
a processor; and
a non-transitory computer-readable medium configured to store instructions executed using the processor to recommend exercise,
wherein the processor is configured, by executing the instructions, to:
generate, for first to n-th questions, first to n-th text combinations by combining at least some of a question text, which corresponds to a question itself, a hint text for the question, and a correct answer text for the question, n being an integer greater than or equal to 2;
embed the first to n-th text combinations into first to n-th question vectors having a predetermined length;
calculate cosine similarity between the first to n-th question vectors to generate a question similarity matrix of size n*n in which a cosine similarity between a p-th question vector and a q-th question vector is an element (p, q), p and q being positive integers less than or equal to n;
generate a first correlation matrix of size n*n by calculating Equation 1 below based on information on whether first to k-th users answered the first to n-th questions correctly or incorrectly, k being an integer greater than or equal to 2,
$$RM1\_ ( r , s ) = \frac{c\_rs}{\sqrt{c\_r * c\_s}} \qquad [ Equation 1 ]$$
wherein in Equation 1, r and s represent positive integers less than or equal to n, RM1_(r, s) represents an element (r, s) of the first correlation matrix, c_r represents a number of users among the first to k-th users who correctly answered a r-th question, c_s represents a number of users among the first to k-th users who correctly answered a s-th question, and c_rs represents a number of users among the first to k-th users who correctly answered both the r-th question and the s-th question;
generate a second correlation matrix of size n*n by calculating Equation 2 below based on the information on whether the first to k-th users answered the first to n-th questions correctly or incorrectly,
$$RM2\_ ( r , s ) = \frac{i\_rs}{\sqrt{i\_r * i\_s}} \qquad [ Equation 2 ]$$
wherein in Equation 2, r and s represent positive integers less than or equal to n, RM2_(r, s) represents an element (r, s) of the second correlation matrix, i_r represents a number of users among the first to k-th users who incorrectly answered a r-th question, is represents a number of users among the first to k-th users who incorrectly answered a s-th question, and i_rs represents a number of users among the first to k-th users who incorrectly answered both the r-th question and the s-th question;
generate a first determination matrix by multiplying the question similarity matrix and the first correlation matrix;
generate a second determination matrix by multiplying the question similarity matrix and the second correlation matrix;
select some of the first to n-th questions to provide the selected questions to a target user;
receive answering results of the target user for the provided questions;
when the target user incorrectly answers a t-th question among the provided questions, calculate a similarity score for each of the remaining questions except for the t-th question among the first to n-th questions using Equation 3 below, t being a positive integer less than or equal to n,
$$SC\_j = SDM1\_ ( t , j ) + SDM2\_ ( t , j ) \qquad [ Equation 3 ]$$
wherein in Equation 3, j represents a positive integer less than or equal to n and different from t, SC_j represents the similarity score for a j-th question, SDM1_(t, j) represents an element (t, j) of the first determination matrix, and SDM2_(t, j) represents an element (t, j) of the second determination matrix; and
recommend a predetermined number of questions among the first to n-th questions to the target user in descending order of the similarity scores.

5. The exercise recommending system of claim 4, wherein when the processor executes the instructions to embed the first to n-th text combinations into the first to n-th question vectors having a predetermined length, the processor embeds the first to n-th text combinations into the first to n-th question vectors having a predetermined length using a sentence transformer related to Natural Language Processing (NLP).

6. The exercise recommending system of claim 4, wherein the processor is further configured, by executing the instructions, to:
generate, for the first to n-th questions, first to n-th chapter texts by collecting a chapter description text included in a chapter related to a corresponding question among a plurality of chapters;
embed the first to n-th chapter texts into first to n-th chapter vectors having a predetermined length; and
calculate cosine similarity between the first to n-th chapter vectors to generate a chapter similarity matrix of size n*n in which a cosine similarity between a p-th chapter vector and a q-th chapter vector is an element (p, q),
wherein when the processor executes the instructions to generate the first determination matrix, the processor generates the first determination matrix by multiplying the question similarity matrix, the chapter similarity matrix, and the first correlation matrix, and
wherein when the processor executes the instructions to generate the second determination matrix, the processor generates the second determination matrix by multiplying the question similarity matrix, the chapter similarity matrix, and the second correlation matrix.
